(19) United States
(12) Patent Application Publication
(10) Pub. No.: US 2020/0164677 A1
(43) Pub. Date: May 28, 2020

(54) Highlighter Mechanica

(71) Applicant: Crystal Sylver, San Francisco, CA (US)

(72) Inventor: Crystal Sylver, San Francisco, CA (US)

(21) Appl. No.: 16/201,373

(22) Filed: Nov. 27, 2018

(51) Int. Cl. B43K 27/02; B43K 21/00; B43K 24/08

(52) U.S. Cl. CPC B43K 27/02; B43K 24/08; B43K 21/00

(57) ABSTRACT

The invention is a refillable highlighter pen and mechanical pencil in one.

### CROSS-REFERENCE TO RELATED APPLICATIONS

Highlighter Mechanica

Provisional Patent Filed Nov. 27, 2017

Application No. 62/707,946

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

The Highlighter Mechanica is a mechanical device. It is a mechanical pencil and a refillable highlighter marker in one.

Highlighters are not recyclable, do not last long, and create tons of consumer waste. One must repeatedly buy several highlighter pens to use, which quickly dry up and must be replaced. This is a waste of plastic and creates more garbage. People often have a jar or drawer of pen, marker, highlighter, and pencil waste because of the disposable nature of the tools.

### BRIEF SUMMARY OF INVENTION

The Highlighter Mechanica combines a mechanical pencil and a highlighter in one. Both of which are refillable, with refillable leads, refillable colored leads, and refillable highlighter marker rods.

The Highlighter Mechanica solves the problems listed above by creating a steel mechanical pencil with refillable highlighter tips that has the ability to last a lifetime, reducing consumer waste and non-recyclable products. The Highlighter Mechanica provides a pencil and highlighter in one, which can easily change between the two. To be used for writing, working, reading, or studying, for students and professionals, youth and adults.

### BRIEF DESCRIPTION OF THE SEVERAL VIEWS OF THE DRAWING

1/2 FIG. 1—Back view of Highlighter Mechanica

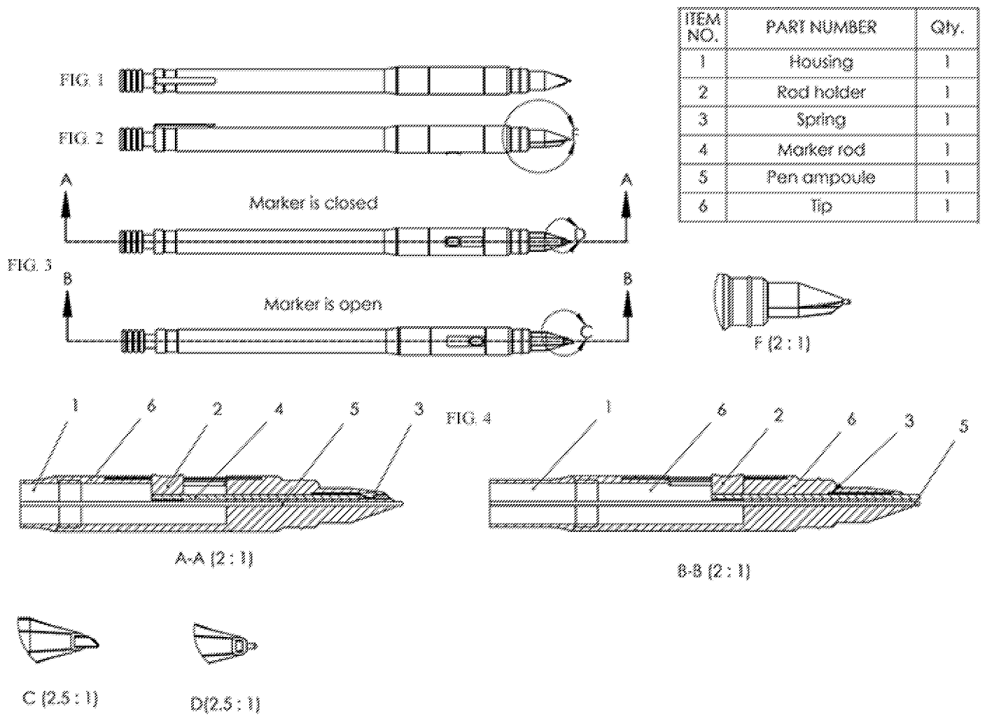

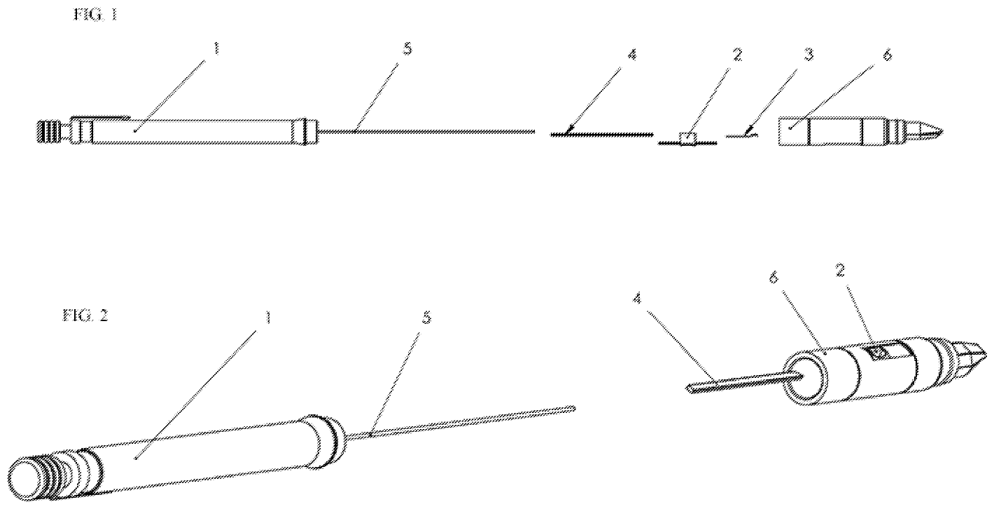

1/2 FIG. 2—Side view of Highlighter Mechanica

1/2 FIG. 3—Top views of Highlighter Mechanica with marker open and closed

1/2 FIG. 4—Cross-section views of Highlighter Mechanica with rod holder up and down

2/2 FIG. 1—Side view of inner mechanics of Highlighter Mechanica

2/2 FIG. 2—Three-quarter view of inner mechanics of Highlighter Mechanica

1. Housing
2. Rod Holder
3. Spring
4. Marker Rod
5. Pen Ampoule
6. Tip

The Housing (1) holds the inner workings of the device. The Rod Holder (2) pushes the Spring (3) and holds the Marker Rod (4) in place. The Pen Ampoule (5) holds the lead. The Tip (6) is the removable top portion of the device.

### DETAILED DESCRIPTION OF THE INVENTION

The Highlighter Mechanica has two tips in one, a lead pencil tip in the center which is held by the pen ampoule and a retractable highlighter marker tip on one side, which raises above the mechanical pencil tip when pushed out by the rod holder. The spring allows the marker rod to be held enclosed inside the device or pushed up for use. The removable tip allows access to the marker rod for replacing when needed.

The Highlighter Mechanica is used as a regular mechanical pencil, as a writing and drawing tool. The Highlighter can be kept down when not in use or pushed up by the rod holder when needed to highlight areas in books or papers.

It is designed to reduce consumer waste and has the ability to last a lifetime through proper maintenance. It can be used in the K-12 education system, in colleges and universities, for students and teachers of all ages, in all business environments, for artists, writers, and for any person who needs a writing tool.

This invention can be used simply as a mechanical pencil without refilling the highlighter marker rod.

This invention can use many different colored marker rods, not just highlighter marker rods.

This invention can use many different colors of lead for writing or drawing.

This invention can create a new refillable highlighter marker and refillable colored marker without the mechanical pencil, using multiple interchangeable colored marker rods to switch colors, which will reduce consumer waste.

This invention can create a new refillable writing pen, which will reduce consumer waste by changing the ink rod.

The Highlighter Mechanica improves upon the current model of highlighter pens and colored markers, by giving customers a high-quality product designed to last a lifetime, which creates minimal waste. Only the highlighter marker rod must be thrown out after use.

This invention is made the same way a steel mechanical pencil is made with the addition of a rod holder and spring that are added internally to one side and a marker tip holder added next to the pen ampoule. The Tip and base can be separated into two pieces.

1. The invention claimed is a Highlighter Mechanica comprised of:
housing with tip designed with a mechanical pencil tip and marker rod tip in one;
a rod holder and spring to retract and extend the marker rod tip, enclosing it when not in use.

2. The Highlighter Mechanica as recited in claim 1, may use many different colored marker rods in addition to highlighter marker rods.

3. The Highlighter Mechanica as recited in claim 1, may not use refillable marker rods but use one disposable marker rod.

4. The Highlighter Mechanica as recited in claim 1, may be made of a number of different materials, including plastic resin or metal.

5. The Highlighter Mechanica as recited in claim 1, may use a number of different methods for creating a marker rod from a felt tip to water and powder form.

6. The Highlighter Mechanica as recited in claim 1, may use a removable tip or another method of replacing the marker rod, such as a side removable panel.
